(19) United States
(12) Patent Application Publication
(10) Pub. No.: US 2026/0024103 A1
(43) Pub. Date: Jan. 22, 2026

(54) PREDICTING VISITOR RETURN USING EMOTION GESTURE CORRELATION

(71) Applicant: Emaww, Longueuil (CA)

(72) Inventors: Alicia Heraz, Longueuil (CA); Nandith Sajith, Longueuil (CA); Abdullah Siddiqi, Longueuil (CA)

(21) Appl. No.: 19/274,210

(22) Filed: Jul. 18, 2025

Related U.S. Application Data
(60) Provisional application No. 63/673,480, filed on Jul. 19, 2024.

(51) Int. Cl. G06Q 30/0201

(52) U.S. Cl. CPC G06Q 30/02011

(57) ABSTRACT

Methods, systems, and apparatus, including computer programs encoded on computer storage media, for predicting a return to a site. In some implementations, a system obtains data indicative of a time evolving movement of a user interacting with a website shown on the client device. The system determines, using a first trained machine learning model and based on the data indicative of the time evolving movement, a metric associated with an emotion of the user corresponding to the user's interaction with the website. The system obtains, from a metric database, metrics associated with an identifier of the user. The system provides, to a second trained machine learning model, (i) the metric associated with the emotion and (ii) data representing the obtained metrics associated with the identifier. The system generates, using the second trained machine learning model, a prediction indicating whether the user is likely to return to the website.

### CROSS-REFERENCE TO RELATED APPLICATION

This application claims the benefit of U.S. Provisional Application No. 63/673,480 filed on Jul. 19, 2024, which is incorporated herein by reference.

### TECHNICAL FIELD

This specifications describes techniques to predict returning visitors to websites using emotion gesture correlation.

### BACKGROUND

Individuals attempt to characterize their emotional state, and to unlock and better understand not only their expressed emotions, but the underlying causes of the expressed emotions. Further, individuals attempt to share indicia of their emotional state based on graphical representations, such as an emoji shared by an individual across a text-messaging platform or among linked members of a social network.

### SUMMARY

The specification describes techniques that measure user emotional experience when visiting a website in terms of degree of user satisfaction, and predicts a return factor of a user for the website according to the emotional experience. In particular, the disclosed techniques determine the effectiveness of user emotional experience as a predictor for future returning of the user to the website.

Traditional web analytics have been limited in their ability to accurately capture the nuances of user experience. Methods like eye tracking, speech tracking, and surveys, while insightful, can suffer from being overly intrusive, leading to biased results. The technology described in this specification provides a non-intrusive method of measuring user experience when interacting with a website. The non-intrusive method includes measuring, for example, touch-gesture based emotion on devices. A system can monitor touch gesture interactions of the user with the website through a display of a client device (e.g., a smart phone, a laptop or desktop computer, a tablet, or the like). The system utilizes a technique that receives a time-evolving, expressive, free-form of one or more portions of an individual's body and further generates a representation of the of the expressed emotion. An expressed emotion may reflect a natural, instinctive state of mind deriving from the individual's circumstances, mood, or relationships with other individuals, and may include, but are not limited to, anger, awe, desire, fear, grief, hate, laughter, love, and scurry. Each of the expressed emotions may be correlated or associated with a detectable intensity. Based on the detected expressed emotion and the corresponding intensity, the system can better analyze the sub-conscious nature of touch gestures and gather emotional data, which allows for a more authentic and unbiased user interaction with websites.

In some implementations, the system can utilize a machine learning artificial intelligence (ML/AI) model that is trained to predict whether a user is likely return to a website or not according to the emotional touch gestures on their previous visit. The trained ML/AI model can produce this prediction with high accuracy, enhanced understanding of user engagement with a particular website, and provides new avenues for optimizing user experience in digital spaces. The system can train the ML/AI model using explicit data collection consent and gathered browsing data on a particular website from a touchscreen device over a previous time period.

In the context of user interaction with websites, particularly those offering purchasing or selecting options, the system can categorize the user experience into two distinct phases. The first phase includes (1) the evaluation stage and the second phase includes (2) the external experience stage. The evaluation stage encompasses system detecting the initial user interaction, e.g., gesture interaction, with the website, during which the user forms an impression or stimuli of the site. The system uses the gesture interaction to detect emotions or inferentially, a user's subconscious during the evaluation stage as this may lead to immediate purchase or selection decisions or influence the user's inclination to revisit the website later. Subsequently, the system analyzes the evaluation stage to produce information related to the external experience stage. The external experience stage extends beyond the direct interaction with the website. For example, the external experience stage encompasses the user's retrospective emotional response to their previous encounter with the website. The retrospective emotional response to their previous encounter with the website can be shaped by their experiences during the evaluation stage.

Consequentially, the system utilizes the detections and understanding of user emotions in the context of website interaction to predict a user's return to the website. This can be important because emotions can influence user decisions in internet environments, such as e-commerce environments, for example, and particularly, whether to return to the website. Traditional web analytics, effective in tracking quantitative aspects such as click-through rates and session durations, lack in comprehending emotional triggers influencing user behaviour. This is significant in digital marketplaces, where emotional engagement impacts purchasing decisions and brand loyalty.

As a result, the system trains the ML/AI algorithm to detect users' emotion and predict a return to an initially visited website according to the detected emotion. In some examples, the ML/AI algorithm can operate across different devices, e.g., client device, personal computers, tablets, and the like. The ML/AI algorithm can predict various emotions. The system can forecast user behavior on a particular site when measuring the non-intrusive touch-based emotion on the website.

In one general aspect, a method is performed by one or more computers, such as a server. The method includes: obtaining, from a client device, data indicative of a time evolving movement of a user interacting with a website shown on the client device; determining, using a first trained machine learning model and based on the data indicative of the time evolving movement of the user interacting with the website, a metric associated with an emotion of the user corresponding to the user's interaction with the website; obtaining, from a metric database, one or more metrics associated with an identifier of the user, wherein the metrics represent data determined from prior interactions of the user with the website; providing, to a second trained machine learning model, (i) the metric associated with the emotion of the user and (ii) data representing the obtained metrics associated with the identifier of the user; in response to the providing, generating, using the second trained machine learning model, a prediction indicating whether the user is likely to return to the website at a future time; and providing, to one or more devices, data representing the prediction as output.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, obtaining the data indicative of the time evolving movement of the user with the website shown on the client device further includes: determining normalized values for the data indicative of the time evolving movement; and generating feature values that characterize the normalized values, wherein the generated feature values comprise at least one of speed, acceleration, contact duration, a change in contact pressure, or a finger size.

In some implementations, obtaining the data indicative of the time evolving movement of the user with the website shown on the client device further includes: obtaining, from the client device, the data indicative of the time evolving movement of a portion of a body of the user with the website shown on the client device, wherein the portion of the body includes a finger and the client device comprises a touchscreen display.

In some implementations, determining the metric associated with an emotion of the user corresponding to the user's interaction with the website includes: obtaining, from the first trained machine learning model, a vector that comprises a plurality of emotions and a likelihood for each emotion of the plurality of emotions, wherein a likelihood represents how likely a corresponding emotion represents the data indicative of the time evolving movement of the user; comparing the likelihood for each emotion of the plurality of emotions to a threshold value; and in response to comparing the likelihood for each emotion of the plurality of emotions to the threshold value, selecting, as the metric associated with the emotion, the emotion of the plurality of emotions whose likelihood satisfies the threshold value, wherein the metric includes a label for the emotion and a corresponding likelihood for the emotion.

In some implementations, obtaining the one or more metrics associated with the identifier of the user further includes: determining the identifier of the user that performed a time evolving movement on the client device with the website; and selecting, from the metric database, the one or more metrics associated with the identifier of the user, wherein the one or more metrics comprise at least one of a session ID, a visitor ID, a visit count, a return, a session duration, a first impression, a number of emotions expressed, a duration of emotions expressed, entry and exit local times, or engagement information.

In some implementations, the second trained machine learning model includes a Light Gradient Boosting Machine.

In some implementations, providing, to a second trained machine learning model, (i) the metric associated with the emotion of the user and (ii) data representing the obtained metrics associated with the identifier of the user further includes providing, to the Light Gradient Boosting Machine, (i) the metric associated with the emotion of the user and (ii) the data representing the obtained metrics associated with the identifier of the user, wherein the Light Gradient Boosting Machine is configured to process numerical and categorical features to predict whether the user is likely to return to the website.

In some implementations, generating, using the second trained machine learning model, a prediction indicating whether the user is likely to return to the website at a future time further includes at least one of: generating, using the second trained machine learning model, a prediction indicating the user is likely to return to the website at a future time; or generating, using the second trained machine learning model, a prediction indicating the user is not likely to return to the website at a future time.

In some implementations, the method further includes: generating a training dataset comprising instances labeled according to whether the user returned to the website; applying an oversampling technique to the training dataset to generate additional instances of the user returning to the website; training a machine learning model using the oversampled dataset, wherein the machine learning model is trained to generate the prediction indicating whether the user is likely to return to the website at a future time; and in response to training the machine learning model, setting the trained machine learning model as the second trained machine learning model.

In some implementations, the data indicative of the time evolving movement of the user comprises a plurality of contacts established sequentially between a finger of the user and a surface of a touchscreen display of the client device at corresponding contact times, wherein the plurality of contacts comprises contact positions, contact pressures, and the contact times associated with each of the contacts.

The subject matter described in this specification can be implemented in various embodiments and may result in one or more of the following advantages. In some implementations, the system provides technical advancements that include predicting a user's return to a website using gesture detection. In some cases, the system can predict emotional features from the gesture detection using one or more trained machine learning models. The predicted emotional features can be further processed by one or more additional trained machine learning models to predict the user's return to the website. This improves prediction accuracy for return likelihood through a user's behavioral analysis over a period of time.

In some cases, the system can recommend adjustments to a website to improve a likelihood of a user's return to that website. The system can analyze data associated with other websites that were detected to have a high likelihood of user return according to detected gestures. This data can include, for example, website layouts, website color schemes, information presentation on the website, and notification location/types, to name some examples. If the system detects a website where a particular gesture resulted in a low return score, the system can determine whether that website with the low return score includes one or more of the features from the other websites. If the system determines the website with the low return score lacks one or more of these features from the other websites, the system can recommend adjustments to a designer of the website in order to improve its likelihood of users returning.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of a system for predicting a user's return to a website according to gesture-based emotion recognition.

FIG. 2 illustrates a graphical representation of ROC result curves for Light Gradient Boosting Machine Model.

FIG. 3 is a flow diagram that illustrates an example of a process for predicting a return to a website according to gesture based emotion recognition.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

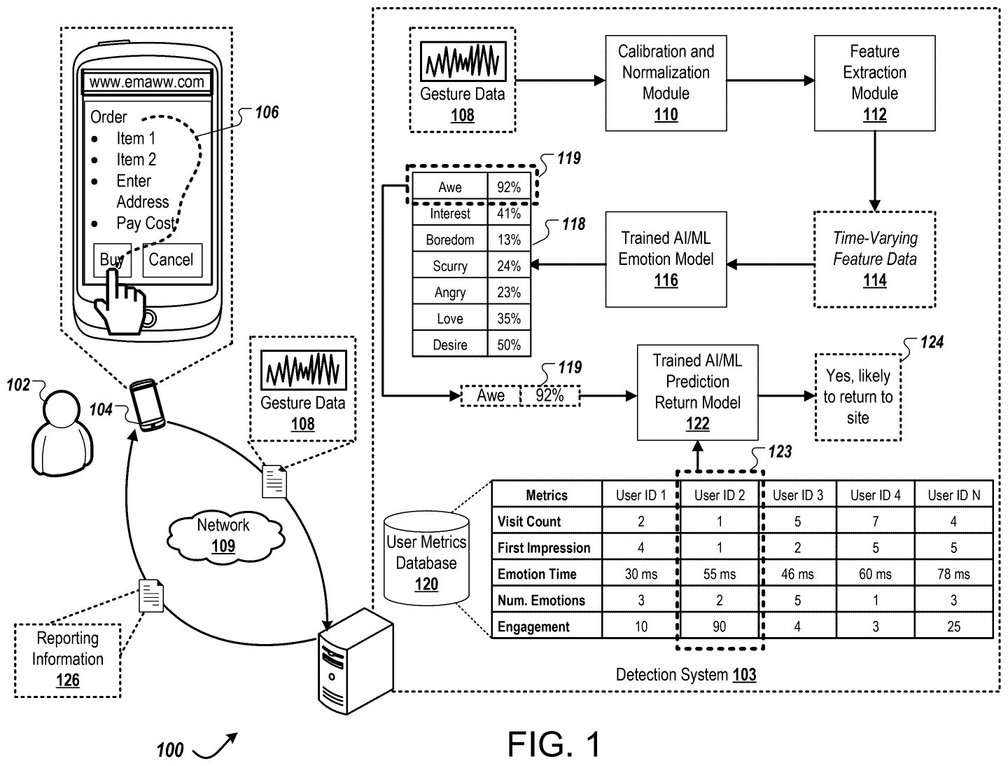

FIG. 1 is a block diagram that illustrates an example of a system 100 for predicting a user's return to a website according to gesture-based emotion recognition. The system 100 includes a detection system 103 and a user metrics database 120. The detection system 103 can communicate with one or more client devices, such as client device 104, over a network 109. The network 109 includes one or more of a wired network, a wireless network, a local network, or an external network, such as the Internet.

Briefly, the detection system 103 can generate a prediction that determines whether user 102 will return to a website displayed on the client device 104. The system can analyze a gesture performed by user 102 on the client device 104 to predict the user's return to the website. For example, specific details related to the gesture detection and analysis can be found in U.S. patent application Ser. No. 15/669,316, the entire contents of which are incorporated herein by reference.

In some implementations, the detection system 103 seeks to predict a user's return to the website displayed on client device 104 using a user's gesture on the client device 104. By predicting the return based on the user's gesture, the detection system 103 can discover or reveal the intention of the user, for example, what the user's gesture reveals about the user's interest or intention with the website. This allows for the detection system 103 to better understand a user's engagement with the website and allows for improving the user's overall experience with the website or with future websites.

The detection system 103 can include one or more servers or computers connected locally or over a network. The system 100 can include a network 109 that can be, for example, local network, a Wi-Fi network, an intranet, an Internet connection, a Bluetooth connection, or some other connection that enables the detection system 103 to communicate, e.g., transmit and receive, with various databases and various computers or client devices.

In some implementations, the detection system 103 can include a user metrics database 120. In some implementations, the user metrics database 120 may be stored locally or connected to the detection system 103 over network 109. The user metrics database 120 can include information associated with user website visits that is calculated and aggregated over a period of time. For example, the user metrics database 120 can include information shown in Table 1 below, for each user's visit to a website. The detection system 103 can acquire data associated with a user's interaction of a website through a respective client device, extract features from the interaction, and store the extracted features in the user metrics database 120.

In some implementations, the processes performed by system 100 is structured into three distinct phases. The first phase involves the collection of emotion data in real-time from a live e-commerce website using the detection system 103. In the second phase, the detection system 103 determines correlations among the available features. In the third phrase, the detection system 103 deploys an AI to predict a user's returning behavior using the detected emotions.

In ensuring ethical compliance and transparency in the data collection process, the detection system 103 adheres to full consent protocols and respects the legal frameworks governing data privacy and protection, including the general data protection regulation (GDPR). Throughout the data collection and beyond, the detection system 103 explicitly informs each user about the data collection through cookies with a clearly worded pop-up notification upon their visit, which can be, for example, a first visit. This notification includes, for example, the nature of the data being collected and its purpose to enhance the user's experience. The notification provides an option for a user to willfully withdraw from the study at any point without affecting their ability to use the website. For example, users who do not consent to cookie usage can still browse the e-commerce website untracked, ensuring their browsing experience remained wholly unaffected by data collection procedures.

To leverage this method, the detection system 103 can obtain explicit data collection consent and gather browsing data from various devices. For example, the detection system 103 can obtain and gather browsing data from 164,527 users across a 1-year period on an ecommerce website visited from a touchscreen device. Using this data, the detection system 103 can train and implement an AI model that predicts whether a user is likely to return to the website or not, primarily based on their emotional touch gestures. The AI model can predict whether the user is likely to return the website or not from their previous visit with an accuracy in the range of 90% or above (e.g., 91.7% in some cases). This approach enhances the detection system 103's understanding of user engagement, and can provide new avenues for optimizing user experience in digital spaces.

In some implementations, the detection system 103 ensures the collected data is anonymized so that users are not individually identifiable. To do this, the detection system 103 does not collect information related IP information and randomly assigns generated Visitor IDs and Session IDs to each user and each session. This approach ensures that the collection aligns with ethical research practices and builds trust with users, reassuring them that their personal information is not at risk of leaking.

Throughout the data collection phase, the detection system 103 can provide emotional expressions in real time as users interacted with the live website. The detection system 103 can restructure the data to summarize the complete emotional journey of users on the website. For example, the detection system calculates additional metrics and aggregates the additional metrics per user and per session.

In the second phase, the detection system 103 analyzes the correlations between the emotional metrics and non-emotional user behaviors. The detection system 103 extracts the most relevant features, for example those that led to a high likelihood of users returning to the e-commerce website, in order to further train the AI predictive model.

In the third phase, the detection system 103 trains the predictive model using a test sample. Here, the detection system 103 trains the model to forecast user return behavior of a website based on their determined and recorded emotional metrics. This methodical approach ensures a comprehensive analysis of emotion-based user engagement in a website based context.

In some implementations, by obtaining active consent for cookie collection, the detection system 103 assigns a unique, anonymous identifier—referred to as a Visitor ID—to each user. This identifier enables the detection system 103 to track all user interactions and behaviors within a session for a particular website and maintain consistency across multiple sessions. As a result, the detection system 103 can utilize the dataset to accurately monitor returning behaviors of users, along with various traditional and emotional metrics. The traditional and emotional metrics, as listed in Table 1 and Table 2 below, ensure a comprehensive understanding of user engagement while respecting privacy through anonymity.

In some implementations, the detection system 103 tracks user interaction for a period of time to build the user metrics database 120. For example, over the course one year, the detection system 103 tracked 164,527 users swiping and scrolling on the website in real-time. The detection system 103 measured and generated the emotion of each swipe, scroll, and click, for example, through touchscreen devices. Through this method, the detection system 103 gathered a data set of 153,766 instances. The detection system 103 which was reduced to 96,393 sessions after data cleaning. Each instance represents a user's session, and all its related metrics are illustrated below in Table 1, which is stored in the user metrics database 120. Users from 84 countries and 1,257 cities were analyzed throughout this study. The users include, for example, Canadian users and users across 855 cities, e.g., 62 metropolitan cities, 78 medium sized cities, 455 small cities and 267 rural areas, throughout all provinces in Canada, resulting in a diverse sample.

In some implementations, the website shown on client device 104 can be displayed in various languages. The languages can include, for example, French, English, Spanish, and other languages.

In order for the system 100 to produce predictions on whether users will return to a website, the trained AI model can include a Light Gradient Boosting Machine model. For example, the detection system 103 trained the Light Gradient Boosting Machine model on 164,527 users to predict with a high degree of accuracy (for example, greater than 90%, such as 91.7% in some cases) whether a user will return or not. In response, the Light Gradient Boosting Machine model established a robust correlation between emotional touch gestures and returning users. The correlation enhances the understanding of user engagement in digital spaces and provides insights for optimizing website design and user experience strategies.

Several studies have been conducted in order to predict user behaviour on web applications with varying accuracy, while research particularly on e-commerce websites is limited. One such study included the use of Visit Duration, money spent in the app, consecutive days visited, inactive time to predict churn with an accuracy in the range of 90% or above (e.g., 97%). However, one study arises, where such a prediction model requires users to extensively interact with the application, without catering to users who interact passively, a growing trend.

One common problem among these studies is that the studies attempt to map user behaviour to in-app actions, while ignoring valuable behaviour data that cannot be understood through clicks and durations. This is where the detection system 103's emotion measurement can gather more detailed user experience data, which can be translated into more accurate and global predictive models.

Emotion recognition and measurement can be captured through diverse inputs and have been employed with varying degrees of effectiveness. These human inputs mainly include eye and facial movements, speech and auditory analysis and lastly touch and non-verbal behaviour analysis. These methods have been studied and implemented to learn and understand human decision making on digital interfaces.

Deep learning techniques applied to speech emotion recognition shows promise in identifying emotional states through vocal cues. These methods utilize the capture of speech then they analyze the tonal variations and speech patterns revealing emotions that can influence user behaviour. While this can be quite effective, these methods' limitation lies in the fact that of requiring environments where vocal interaction is natural and prevalent, such as call centres or voice-assisted services. This can increase bias and the intrusive nature of the interaction, but is becoming less common as ecommerce is shifting towards a completely digitized, self-service environment. Moreover, since this requires extensive time to collect data, this method presents difficulty in gathering sufficient data to build predictive models.

In some implementations, the detection system 103 can utilize facial recognition to detect emotions. Facial emotion recognition is a technology that identifies human emotions from facial expressions. Facial emotion recognition requires the capture of a video or a series of images, this data is then processed through algorithms that detect changes in facial movement attributed to specific emotions. Facial recognition is effective in various applications, such as mental health assessment, marketing, and human-computer interaction, with its effectiveness depending on factors like lighting conditions, the subject's position, and cultural variations in expressions, to name a few examples. However, there are many limitations in facial recognition, such as potential biases in the algorithms, particularly regarding age, gender, and ethnicity, and the challenge of accurately interpreting subtle or mixed emotions. Moreover, variation in facial recognition capture methods can lead to highly varying results. As a result, there is significant pushback in the consumer world as facial recognition presents a highly intrusive method for emotion recognition.

One type of traditional user experience measurement that has been implemented for numerous years is post-evaluation surveys and questionnaires. The post-evaluation surveys and questionnaires allow users to complete their online experience without bias and intrusion and by simply asking users to recollect and detail their experience, their emotional journey can be assessed. Such methods, while valuable for their non-intrusive nature, may not adequately capture the real-time, nuanced emotional experiences of users. The delay between experience and recollection can introduce memory biases, affecting the accuracy of the feedback. Therefore, while useful, these traditional methods may not fully represent the immediate emotional responses that users have during their online interactions, introducing significant noise (variation) in a predictor.

Another approach includes a non-intrusive emotion measurement is the use of consumer-grade digital wearables. The consumer-grade digital wearables track key physiological parameters like heart rate variability and skin temperature, employing AI algorithms to deduce the wearer's emotional states. While this method is noted for its accuracy and seamless integration into daily life, this method faces limitations in application breadth. The broad scope of this application can hinder the precise identification of specific emotional triggers, especially in the context of online experiences. Consequently, predicting future behaviors based on specific online stimuli becomes challenging, impacting the method's effectiveness in certain applications.

Touch gesture and emotion recognition using movement sensitive sensors, such as consumer grade touch screens, represents a significant advancement in non-intrusive emotion measurement. By analyzing touch interactions, this method captures subtle emotional expressions, offering insights into user states without the biases of direct questioning or observation. Its applications are vast, especially in web-based and touchscreen-based technologies, providing a more nuanced understanding of user engagement and preferences, for example in an ecommerce environment.

The comparison of the most prevalent emotion AI measurement techniques today highlights that although each method can achieve a high level of accuracy, the effectiveness of these methods also depends on their accessibility, availability, and the context in which they are used, especially in the case of autonomous, online experiences.

A notable gap in the field of emotion measurement is the limited use of these methods in predicting future online behaviors. These existing methods are highly capable and often used to measure user emotions in real-time, but its effectiveness in future behaviour prediction is yet to be tested. Non-intrusive touch-based emotion recognition, with its ability to continuously and real-time monitor emotions, provides a consistent data stream. This consistency is important in accounting for variations in user responses that may arise due to factors like seasonality. Visit duration—not only does this show low feature importance as the detection system 103 trains the model; Visit Duration is known to not be an accurate predictor of user experience.

For each instance in the dataset, the following features in Table 1 were calculated by the detection system 103. These include emotional and traditional metrics.

TABLE 1
List of Features Collected

| Feature | Description |
|---|---|
| Session ID | Unique Session Identifier |
| Visitor ID | Unique User Identifier |
| Visit Count | Number of Visits |
| Return | Binary: 0 if the user visits the website for the first time, 1 if |
| | the user is a returning user. This is based on the user's Visit |
| | Count. |
| Session Duration | Duration in milliseconds |
| First Impression | Score from 0 to 5, as described in III. B Feature Extraction. |
| Number of Emotions expressed | Count of Awe, Interest, Scurry, Boredom gestures as |
| | explained in Table 1. |
| Duration of Emotions expressed | Duration of Awe, Interest, Scurry, Boredom gestures in |
| | milliseconds. |
| Entry and Exit Local Times | Morning (6:00 AM to 11:59 AM), Afternoon (12:00 PM to |
| | 5:59 PM), Evening (6:00 PM to 11:59 PM), Night (12:00 |
| | AM to 5:59 AM) |
| City and Country | City and Country of User |
| Engagement | Number of buttons clicked on the website |

In building the model, the detection system 103 can produce the features shown in Table 1 and carefully evaluated the Mean Decrease in Impurity (MDI). For the MDI, the detection system 103 ensures the total sum of importance sums to value of 1. The detection system 103 removed features that showed very insignificant contributions (MDI ˜0). These features included: Session Duration, City and Country, and Exit Local Times. In some cases, fewer features were not included for the model, such as Session Duration and 3 values of Entry Local Time (Morning, Afternoon, Night—refer to Table 2).

In some implementations, the detection system 103 relied on various information to determine a user's return to a website. This information includes, for each unique user: (1) a user's emotion data, (2) the detection system 103's calculated emotional metrics, and (3) the traditional user experience data.

As illustrated in FIG. 1, user 102 can interact with a website shown on client device 104. The user 102 may perform a gesture 106 on the client device 104 using their finger or fingers. For example, the user 102 may perform gesture 106 by dragging his finger on the touch screen display along a particular path, such as to view a different part of the screen, tap on a GUI element, or resize the screen. The client device 104 may capture and record this gesture 106 as gesture data 108.

The gesture data 108 may include a continuous set of pressure points on the touch screen display over a period of time. For example, the gesture data 108 can include contact points along the touch screen display of client device 104 at specific times. The contact points can additionally include a pressure amount that indicates the pressure at which the user 102 pressed his or her finger or fingers at that point on the touch screen. The client device 104 can packetize the gesture data 108 and transmit the packetized gesture data 108 over the network 109 to the detection system 103.

Upon receipt of the gesture data 108 from client device 104, the detection system 103 can provide the gesture data 108 to the calibration and normalization module 110. The calibration and normalization module 121 can perform operations that calibration portions of the gesture data 108 to reflect one or more characteristics of the user and the user's operation of the client device 104. For example, the client device 104 may capture calibration data indicative of a maximum pressure applied to the touchscreen of the client device 104 during a corresponding calibration period, and may transmit the captured calibration data to the detection system 103, which may associate the calibration data with the user 102 and the client device 104, and store the calibration data in the user metrics database 120. Other functions of the calibration and normalization module 121 can be found in U.S. patent application Ser. No. 15/669,316.

The calibrated and normalized features are provided to the feature extraction module 112. The feature extraction module 112 can process portions of the calibrated and normalized movement data to derive features that characterize the time-evolving movement of one or more portions of the user 102's body. For example, the feature extraction module 112 may access portions of the normalized positional data and calibrated applied-force data to identifying the normalized, two-dimensional contact positions and calibrated applied-pressure values at each of the discrete detection times. The feature extraction module 112 may, in some instances, compute “micro-differences” in two dimensional positions and applied pressure between each of the discrete detection times, and based on the computed micro-differences, derive values of one or more features that characterize the time-evolving movement of the user's finger during the current collection period. Other functions of the feature extraction module 112 can be found in U.S. patent application Ser. No. 15/669,316.

The feature extraction module 112 can generate time-varying feature data 114. The generated feature data 114 includes data that identifies the derived feature values that characterize the movement of the user's finger at discrete detection times during the current collection, and the detection system 103 can provide the generated feature data 114 as input to a trained AI/ML emotion model 116. The trained AI/ML emotion model 116 can determine, from the generated feature data 114, one or more emotions represented by the free-form movement of the user's finger or fingers, e.g., gesture 106, on the touchscreen of the client device 104. In some examples, the process by which the trained AI/ML emotion model 116 determines one or more emotions using the generated feature data 114 can be found in U.S. patent application Ser. No. 15/669,316.

The trained AI/ML emotion model 116 can generate a set of emotions and a likelihood for each emotion that represents the free-form movement of the gesture 106. For example, the set of emotions can include awe, interest, boredom, scurry, angry, love, desire, and others. Table 2 illustrated below illustrates a set of emotions and their corresponding descriptions. The terminology used to label these emotions is not intended to be exhaustive or uniquely defined. For example, terms such as “awe,” “interest,” “boredom,” and “scurry” are descriptive words whose selection was informed by the observable emotional expressions commonly encountered during web browsing activities. The selection process also accounted for the evolving understanding of emotional states in the context of browsing a web page, incorporating insights from user feedback and empirical observations.

TABLE 2
List of Emotions that Emaww API collects

| Emotion | Description |
|---|---|
| Awe | Awe is a wondrous expression where users become deeply moved and |
| | connected to the content. They are almost frozen as they absorb new |
| | material that resonates with their interests and captivates their minds. |
| Interest | When users are interested, they exhibit attentiveness and curiosity towards |
| | the content. They browse it with enough focus to grasp its meaning. |
| Boredom | Users who are bored have likely reached their maximum attention span, |
| | causing fatigue that leads to disengagement. As a result, they may become |
| | jaded with the content. |
| Scurry | Scurrying users are preoccupied and completely disconnected from the |
| | content. As they frantically browse, they exhibit a sense of urgency and |
| | rush that corresponds to a very low level of focus. |

In some cases, the trained AI/ML emotional model 116 can be a Gradient Boosting Classifier. The trained AI/ML emotional model 116 can be trained to produce various emotions, including the emotions outlined in Table 2. The trained AI/ML emotional model 116 can produce the various emotions by leveraging the nine distinct gestures properties from which the model attributes were extracted in Table 3.

Here, the trained AI/ML emotional model 116 can be configured with specific hyperparameter settings tailored to optimize performance. For example, the algorithm's cost complexity pruning alpha is set to 0.001, and the trained AI/ML emotional model 116 utilizes a Friedman mean squared error criterion. The trained AI/ML emotional model 116's initialization was conducted without any specified initializations, and the learning rate was set to 0.1, employing logarithmic loss as the loss function. To control model complexity, the detection system 103 restricted the maximum depth of each tree to 3, and there was no limitation on the number of features.

Additionally, no maximum leaf nodes were specified. Impurity decreases smaller than 0.0 were not allowed, and the minimum samples per leaf and split were set to 1 and 2, respectively. Weight fractions for leaf nodes and the number of estimators were set to 0.0 and 100, respectively. There was no limit specified on the number of iterations without improvement. For reproducibility, the random state was set to 123, and a subsample ratio of 1.0 was used. The tolerance for stopping criteria was set to 0.0001, and a validation fraction of 0.1 was employed. The detection system 103 executed the algorithm without verbose output and without warm starting.

Before integrating the gestures attribute into the trained AI/ML emotion model 116, the gestures attribute underwent two preprocessing steps: normalization and calibration with the calibration and normalization module 110. Normalization involved scaling the attribute values to a standard range or distribution, ensuring that each attribute contributed equally to the model's learning process. Calibration, on the other hand, involved fine-tuning the attribute values to account for variations across different devices and data collection periods.

TABLE 3
List of Gesture Properties that Emaww API Uses

| # | Property | Description |
|---|---|---|
| 1 | Gesture Duration | The time elapsed between the beginning and end of the gesture, |
| | | measured in milliseconds (ms). |
| 2 | Pause Length | The duration of periods where there is no new touch event input |
| | | during the gesture, measured in milliseconds (ms). |
| 3 | Touch Count | The number of distinct touch points registered during the gesture |
| | | (unitless). |
| 4 | Gesture Spread | The difference between the maximum and minimum X and Y |
| | | coordinates of touch points during the gesture, measured in pixels |
| | | (px) for both X and Y axes. |
| 5 | Gesture Direction | The angle between the initial and final touch points relative to a |
| | | reference axis, measured in degrees (°). |
| 6 | Gesture Travel | The total distance covered by the touch points during the gesture, |
| | | considering each movement between subsequent touch points, |
| | | measured in pixels (px). |
| 7 | Gesture Area | The area covered by the touch points during the gesture, measured in |
| | | square pixels (px²). |
| 8 | Gesture Speed | The average speed of the gesture, calculated by dividing the total |
| | | distance traveled by the gesture duration, measured in pixels per |
| | | second (px/s). |
| 9 | Gesture Acceleration | The rate of change of gesture speed over time, estimated by |
| | | analyzing the change in velocity between subsequent time intervals, |
| | | measured in pixels per second squared (px/s²). |

In some implementations, the detection system 103 continuously trains the trained AI/ML emotion model 116. Training can include parameter tuning and algorithmic adjustments. As a result, the trained AI/ML emotion model 116 achieves a high accuracy, e.g., greater than 90%, such as an accuracy of 91.03%, and a high precision rate, e.g., greater than 90%, such as a precision rate of 92.07%, solidifying its reliability even as it continues to evolve with ongoing data accumulation.

In some implementations, the trained AI/ML emotional model 116 can output the vector of emotions 118. The vector of emotions 118 includes a likelihood that the gesture data 108 represents the corresponding emotion. The detection system 103 can select the emotion whose likelihood satisfies a threshold value. For instance, if the threshold value is set to 90%, the detection system 103 can select the emotion of awe, whose likelihood is 92%. The selected emotion 119, e.g., awe with a 92% likelihood, is provided as input to the trained AI/ML prediction return model 122.

In some implementations, the detection system 103 can generate a first impression metric using the selected emotion 119. The First Impression metric reflects the initial perception or impression a user forms upon landing on a website. This metric captures the emotional reaction to the first element a user encounters or experiences upon arrival on the website of the client device 104. The design and implementation of this metric are grounded in extensive research highlighting the pivotal role of first impressions in shaping user experiences on websites. Studies within the fields of web design and human-computer interaction have consistently shown that users form quick judgments regarding a website's credibility, usability, and aesthetic appeal within the initial few seconds of a visit. These early assessments can influence user engagement, satisfaction, and retention rates, underscoring the importance of capturing and understanding first impressions in the context of user interactions with web platforms. The discrete values for the first impression metric include:
0: A user who leaves the website within 250 ms of loading;
1: Initially expressing indifference;
2: Expressing an initial emotion of Boredom or Scurry;
3: Neutral or expressing no emotion while upon landing;
4: An initial act of clicking a button available on the webpage; and
5: Initially Expressing Awe or Interest Emotions.

Entry and Exit Local Times, City and Country and Engagement are metrics or data types.

The detection system 103 leverages the unique combination of measured emotional data, emotional metrics, and traditional user experience indicators to develop a highly accurate predictive model that determines whether one will return to the website shown on client device 104.

A series of decision tree classifiers were evaluated for their interpretability, logistic regression for its straightforward binary classification capabilities, and Random Forest models to improve accuracy through ensemble learning. These methods were chosen for their suitability in addressing the complex patterns and relationships present in the data captured by the detection system 103. The chosen machine learning models are known for their efficacy in handling imbalanced datasets. These models can be designed to manage the challenges posed by data where one class is significantly underrepresented. Techniques such as decision trees in Extra Trees and Random Forest classifiers, and stage-wise model building in Gradient Boosting, help reduce bias towards the majority class.

Due to the natural characteristics of web behavior, returning users tend to be underrepresented in the dataset. Consequently, a resampling technique known as SMOTE (Synthetic Minority Over-sampling Technique) was implemented, which creates synthetic samples for the minority class (returning users) to address this issue. SMOTE is effective at reducing error and increasing accuracy, particularly for Tree-Based models and models that include multiple features (at least more than 1).

These diverse methodologies ensured robust and reliable predictions, overcoming the common issues of bias and overfitting in imbalanced datasets.

Table 4 highlights the sample size before and after the SMOTE transformation.

TABLE 4
Filtered and SMOTE Sample Sizes

| | Sample Size |
|---|---|
| Filtered | 82,163 |
| SMOTE Adjusted | 130,537 |

The transformation allowed the positive and negative cases to be equally represented within the dataset and allowed the final sample size to be sized over 100,000 users, allowing for robust conclusions.

In Table 5, the top five most accurate and precise models are listed from those evaluated using the resampled data. These models are most capable of predicting whether a user will return to a website or not based on the number of positive emotions expressed by the individual during their initial visit. The optimal set of hyperparameters chosen for each of the five machine learning models has been identified and is presented below.

TABLE 5
Comparison of Accuracy and Precision of Algorithms Tested

| Algorithm and its Parameters and Values | Accuracy | Precision |
|---|---|---|
| Light Gradient Boosting Machine: (boosting_type = gbdt; class_weight = None; | 0.9173 | 0.8822 |
| colsample_bytree = 1; importance_type = split; learning_rate = 0.1; max_depth = −1; | | |
| min_child_samples = 20; min_child_weight = 0.001; min_split_gain = 0; | | |
| n_estimators = 100; n_jobs = −1; num_leaves = 31; objective = None; | | |
| random_state = 123; reg_alpha = 0; reg_lambda = 0; subsample = 1; | | |
| subsample_for_bin = 200000; subsample_freq = 0;) | | |
| Extreme Gradient Boosting: (base_score = None; booster = gbtree; | 0.9128 | 0.8764 |
| callbacks = None; colsample_bylevel = None; colsample_bynode = None; | | |
| colsample_bytree = None; device = cpu; | | |
| early_stopping_rounds = None; enable_categorical = False; eval_metric = None; | | |
| feature_types = None; gamma = None; grow_policy = None; | | |
| importance_type = None; interaction_constraints = None; learning_rate = None; | | |
| max_bin = None; max_cat_threshold = None; max_cat_to_onehot = None; | | |
| max_delta_step = None; max_depth = None; max_leaves = None; | | |
| min_child_weight = None; missing = nan; monotone_constraints = None; | | |
| multi_strategy = None; n_estimators = None; n_jobs = −1; | | |
| num_parallel_tree = None; objective = binary;) | | |
| Gradient Boosting Classifier: (ccp_alpha = 0; criterion = friedman_mse; | 0.9092 | 0.8826 |
| init = None; learning_rate = 0.1; loss = log_loss; max_depth = 3; | | |
| max_features = None; max_leaf_nodes = None; min_impurity_decrease = 0; | | |
| min_samples_leaf = 1; min_samples_split = 2; min_weight_fraction_leaf = 0; | | |
| n_estimators = 100; n_iter_no_change = None; random_state = 123; | | |
| subsample = 1; tol = 0.0001; validation_fraction = 0.1; verbose = 0; | | |
| warm_start = False;) | | |
| AdaBoost Classifier: (algorithm = SAMME.R; estimator = 50; learning_rate = 1; | 0.8935 | 0.8814 |
| n_estimators = 50; random_state = 123;) | | |
| Random Forest Classifier: (bootstrap = True; ccp_alpha = 0; | 0.8883 | 0.8673 |
| class_weight = None; | | |
| criterion = gini; max_depth = None; max_features = sqrt; | | |
| max_leaf_nodes = None; max_samples = None; min_impurity_decrease = 0; | | |
| min_samples_leaf = 1; min_samples_split = 2; | | |
| min_weight_fraction_leaf = 0; monotonic_cst = None; n_estimators = 100; | | |
| n_jobs = −1; oob_score = False; random_state = 123; verbose = 0; | | |
| warm_start = False;) | | |

After presenting the parameters of the algorithms used, including Light Gradient Boosting Machine, Extreme Gradient Boosting, Gradient Boosting Classifier, AdaBoost Classifier, and Random Forest Classifier, along with their corresponding accuracy scores on both training and validation datasets, it is evident that each algorithm demonstrates varying degrees of predictive performance.

Light Gradient Boosting Machine achieved the highest accuracy on both training and validation sets, with scores of 0.9173 and 0.8822, respectively, indicating its robustness in capturing the underlying patterns in the data: the boosting type is set to ‘gbdt’, indicating the traditional gradient boosting decision tree framework employed. Notably, no class weights are assigned, underscoring the model's reliance on balanced class distributions. With a colsample_bytree value of 1, the algorithm considers all features when constructing individual decision trees, ensuring comprehensive coverage of the input space. The learning rate of 0.1 controls the step size during gradient descent, balancing between rapid convergence and overshooting. Despite the absence of a predefined maximum depth (−1 indicates no limit), the algorithm effectively manages model complexity through other parameters such as min_child_samples (set to 20) and num_leaves (set to 31), ensuring optimal tree growth. Furthermore, regularization techniques are employed, as evidenced by reg_alpha and reg_lambda values of 0, indicating minimal penalty on feature importance. With n_estimators set to 100, the model constructs an ensemble of decision trees, while leveraging all available computational resources (n_jobs=−1). These parameters collectively define a powerful predictive framework, capable of capturing intricate patterns within the data while mitigating the risk of overfitting.

In environments with high website traffic, the volume of data to process is massive. Accuracy can be an important metric here because it ensures that the model performs well overall, handling both positive and negative cases effectively. A high accuracy rate implies that the model is reliable in generalizing from the training data to unseen data, which is important in a high-traffic environment.

The emphasis on precision can be important in the context of unbalanced datasets, a common issue in real-world scenarios. In unbalanced datasets, certain classes are underrepresented, which can lead to models that are biased towards the majority class. Similarly, a high recall indicates that the model is particularly sensitive to the positive cases.

In order to better understand the features used in this study and validate that they were adequate for this research, it is important to ensure that there is variation in the data. Moreover, it also serves as an important snapshot of the sample used in this research.

Table 6 below shows the summary statistics of the variables chosen for this study.

TABLE 6
Summary Statistics of Features Selected

| | | | | Standard |
|---|---|---|---|---|
| Index | Mean | Median | Mode | Deviation |
| Unique URLs Visited | 1.16 | 1 | 1 | 0.87 |
| Visit 1 Awe Count | 1.64 | 0 | 0 | 4.04 |
| Visit 1 Interest Count | 4.49 | 2 | 0 | 7.29 |
| Visit 1 Scurry Count | 0.10 | 0 | 0 | 0.76 |
| Visit 1 Boredom Count | 0.00 | 0 | 0 | 0.09 |
| Visit 1 Awe Duration | 2612.34 | 0 | 0 | 16874.88 |
| Visit 1 Interest Duration | 12432.37 | 5858 | 0 | 22988.82 |
| Visit 1 Scurry Duration | 495.32 | 0 | 0 | 4687.58 |
| Visit 1 Boredom Duration | 19.54 | 0 | 0 | 715.59 |
| Visit 1 First Impression | 4.69 | 5 | 5 | 0.82 |
| Visit 1 Engagement | 1.29 | 0 | 0 | 3.78 |
| Entry Local Time | N/A | N/A | Morning | N/A |

The overall tendency of users is to express multiple instances of the emotion Interest with a relatively high emotional duration, as well as record a high First Impression during their visit. Together, the features show a relatively high Coefficient of Variation (CV). This makes such variables useful for predictive models as higher variation leads to more nuanced samples, leading to effective training and high accuracy and precision.

The following Table 7 shows the sample of data used for training and testing the model. Each row represents a specific user, browsing a single page in a singular session. The data used for training and testing is stored in the user metrics database 120. The Return as well as the 12 features are recorded for each user and session.

TABLE 7
Cleaned Data Sample Used for Training and Testing

| | Visit 1 | Visit 1 | Visit 1 | Visit 1 | Visit 1 | Visit 1 | Visit 1 | Visit 1 | Visit 1 | Unique | | Entry |
|---|---|---|---|---|---|---|---|---|---|---|---|---|
| | Awe | Interest | Scurry | Boredom | Awe | Interest | Scurry | Boredom | First | URLs | Visit 1 | Local |
| Return | Count | Count | Count | Count | Duration | Duration | Duration | Duration | Impression | Visited | Engagement | Time Type |
| 0 | 0 | 42 | 16 | 1 | 0 | 101635 | 1375 | 4766 | 5 | 3 | 1 | morning |
| 0 | 0 | 2 | 0 | 0 | 0 | 4143 | 0 | 0 | 5 | 1 | 0 | afternoon |
| 0 | 7 | 4 | 14 | 1 | 782 | 12305 | 1343 | 3408 | 5 | 1 | 2 | morning |
| 0 | 1 | 3 | 0 | 0 | 5686 | 11532 | 0 | 0 | 3 | 1 | 0 | morning |
| 1 | 0 | 6 | 6 | 1 | 0 | 7170 | 537 | 3966 | 5 | 1 | 0 | afternoon |
| 1 | 0 | 2 | 4 | 1 | 0 | 3072 | 339 | 3786 | 5 | 1 | 0 | morning |
| 0 | 12 | 39 | 0 | 0 | 22560 | 72768 | 0 | 0 | 0 | 8 | 1 | morning |
| 0 | 0 | 23 | 5 | 3 | 0 | 27033 | 619 | 4625 | 3 | 1 | 0 | evening |
| 0 | 3 | 1 | 0 | 0 | 8149 | 14100 | 0 | 0 | 5 | 1 | 0 | afternoon |
| 1 | 1 | 3 | 0 | 0 | 967 | 544 | 0 | 0 | 5 | 1 | 3 | morning |
| 0 | 2 | 1 | 0 | 0 | 259 | 1001 | 0 | 0 | 5 | 1 | 0 | afternoon |

The Light Gradient Boosting Machine model, selected as the model for this project, stood out as the desired choice given the unique characteristics of the dataset as shown below in Table 8. For example, the trained AI/ML prediction return model 122 utilizes the Light Gradient Boosting Machine model.

To resolve the imbalance nature of the dataset, the SMOTE method was implemented, as mentioned previously. The following Table 8 summarizes the characteristics of the final model.

TABLE 8
Design and Transformation and Classification
of Algorithm Implemented

| Description | Value |
|---|---|
| Model Algorithm | Light Gradient Boosting Machine |
| Target | Return |
| Target Type | Binary |
| Fix Imbalance | TRUE |
| Imbalance Method | SMOTE |
| Train Set | 90% of Transformed Data |
| Test Set | 10% of Transformed Data |
| Number of Features | 12 |
| Numeric Features | 11 |
| Categoric Features | 1 |
| Fold Generator | StratifiedKFold |
| Fold Number | 10 |

The Light Gradient Boosting Machine is particularly well-suited for this enriched dataset as the trained AI/ML prediction return model 122. Its ability to handle both categorical and numerical data makes it versatile to use in this experiment given the dataset's composition of 11 numeric and 1 categorical feature. The selected model's structure is also especially adept at handling the complexities of a binary target with its diverse target mapping (0:0, 1:1), allowing for accurate decision-making based on the binary classes.

For example, the trained AI/ML prediction return model 122 can receive as input the selected emotion 119 and data 123 retrieved from the user metrics database 120. The data 123 retrieved from the user metrics database 120 can include, for example, data representative of the list of features. This list of features, such as those described in Table 1, represent metrics calculated from user 102's interaction with the website on client device 104. This list of features includes, for example, the visit count, the first impression metric, a detected emotion time or duration, number of emotions, and engagement, to name some examples. The trained AI/ML prediction return model 122 can process (i) the selected emotion 119 and its likelihood and (ii) the data 123 retrieved from the user metrics database 120 calculated for the user 104's session.

In response, the trained AI/ML prediction return model 122 can process the input and generate an output 124. The output 124 can include, for example, a binary decision that indicates either (i) yes, the corresponding user is likely to return to the site or (ii) no, the corresponding use is not likely to return to the site. In some cases, the detection system 103 can provide the output 124 to a developer of the site, to a third-party company, and/or to the client device 104. The output 124 can be provided as reporting information 126, which can include information showing how the detection system 103 arrived at its output 124. This information can include, for example, data identifying the time-varying feature data 114, the vector of emotions 118, and the data 123 selected from the user metrics database 120.

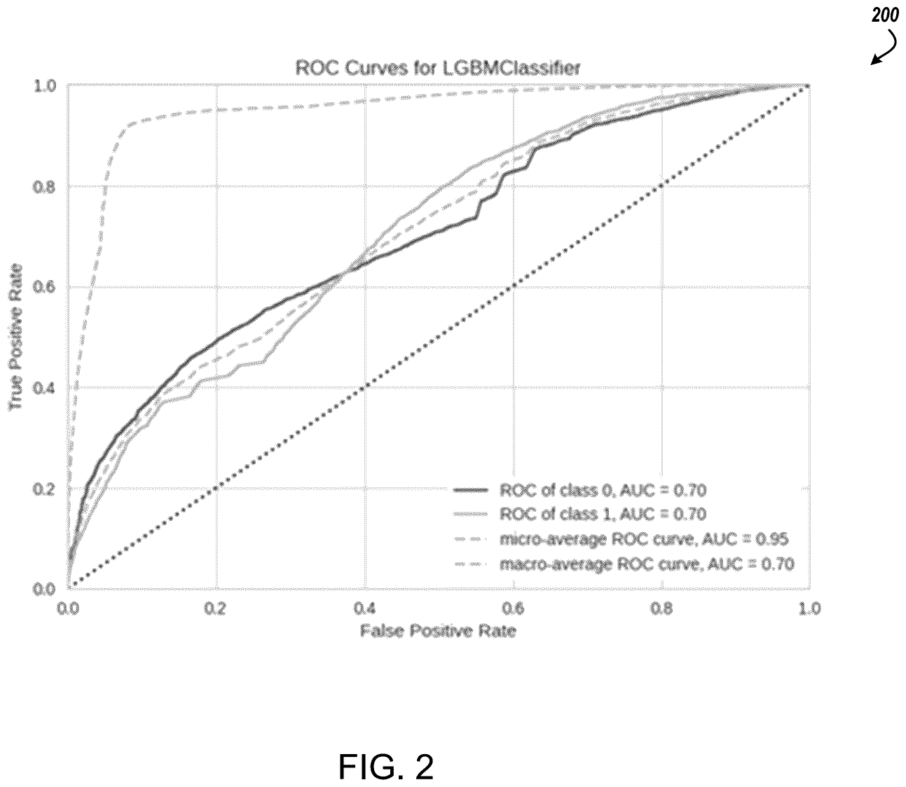

As shown in FIG. 2, when predicting whether a user will return to the website or not, each individual emotional and quantitative metric alone is not a good predictor of Returning (Boolean: Yes/No). However, aggregating emotional and quantitative metrics allows the model to predict a user's return to the website, from the emotional metrics recorded during their previous visit only, with an accuracy greater than 90%, e.g., such as 91.7% accuracy.

The model's micro-average ROC AUC of 0.95 suggests a high overall accuracy for the aggregated outcomes across all classes, indicating strong performance in distinguishing between positive and negative instances on a global scale.

The Table 9 below also record more precision results:

TABLE 9
Accuracy Statistics of Resulting Light GBM Model

| Precision Statistic | Value |
|---|---|
| Accuracy | 0.9173 |
| Recall | 0.9173 |
| Precision | 0.8822 |
| F1-Score | 0.8899 |

Given these values, the results show that the model appears to perform well in terms of both identifying positive cases, e.g., high recall, and in being correct when it predicts a positive case, e.g., high precision. The balance between precision and recall, as indicated by the F1-score, is also good.

Moreover, testing the model on more data from the same ecommerce website, without retraining resulted in an accuracy greater than 90%, e.g., such as 91.3% accuracy. A similar test conducted on another ecommerce website, with users predominantly from the USA, showed that the model could predict if a user would return to this separate ecommerce website with an accuracy greater than 85%, e.g., such as 88.0% accuracy, further proving the model's capability in a generalized environment.

The features and accuracy of the results suggest that while it is difficult to predict returning users from traditional metrics alone (for example, from users' session duration), the trained AI/ML prediction return model 122 can predict returning users from their emotions on their previous visit.

In some cases, the previous visit corresponds to the user's first or initial visit to the website. User behaviors can show significant variance, particularly in the count and duration of emotional expressions of Awe and Interest, and their engagement during their first visit. This variability can impact Return, e.g., whether or not the user will return. For example, users displaying higher emotional counts and duration, along with engagement, tend to have increased likelihoods or returning to the website. However, in some cases, the AI/ML prediction return model 122 is trained to measure user emotion on any visit, and predict whether the user will return to visit the website based on the measurement.

In the context of a digital marketplace, the findings indicate that users who consistently exhibit emotion of Awe or Interest during their interaction with the platform demonstrate a higher propensity to revisit the platform compared to those who display disengagement. A significant challenge encountered in prior methodologies for recording user emotions and experiences lies in the costly nature of obtaining feedback from disengaged users. Identifying and analyzing users with negative experiences can present substantial difficulties, necessitating the reliance on non-intrusive methods as the sole viable approach to gather insights on this category of users.

In evaluating the emotional responses manifested during initial customer interactions, such experiments can effectively estimate user satisfaction and prospective advocacy. This concept is similar in nature to net promoter scores, while offering the advantage of not facing difficulties in gathering manual customer feedback. This pre-emptive assessment of customer sentiment provides a timely and potentially insightful metric for gauging initial consumer engagement and satisfaction.

In conclusion, this research presented a significant advancement in understanding the predictive emotional features of user behavior on e-commerce websites, for example whether a user will decide to return to the website in the future or not. The approach in utilizing gesture-based emotion measurement as a predictor for returning visitors marks a noteworthy contribution to the field of user experience research.

For example, the gesture-based emotion-recognition algorithm was live on an ecommerce website for 1 year, recording emotion gestures of 164,527 users in real-time. During this time, four emotions were recorded for each user: Awe, Interest, Scurry and Boredom counts as well as their total durations as well. Traditional metrics for each user were also tested: Visit Duration, Engagement Count, Entry Local Time and during the feature selection phase, Visit Duration was removed as it did not serve as an accurate predictor of whether a user will return to the website.

These features were engineered to build a Light Gradient Boosting Machine model, e.g., the trained AI/ML prediction return model 122, that predicts whether a user will return to the website in the future or not with an accuracy greater than 90%, e.g., such as 91.7% accuracy, by relying on emotion metrics of counts and durations of Awe, Interest, Scurry and Boredom for each user, as well their number of Engagements, First Impression and Entry Local Time of each user's first visit.

The findings demonstrate that subconscious emotional expression, as interpreted through touch gestures, can be effective indicators of future behavior. This insight opens new avenues for enhancing user experience and can be leveraged to improve customer retention strategies in digital platforms. The encouraging result of this study establishes a foundation for future research on incorporating emotion recognition technologies into user experience design. It opens avenues for detailed examination of individual design elements to enhance website performance optimally.

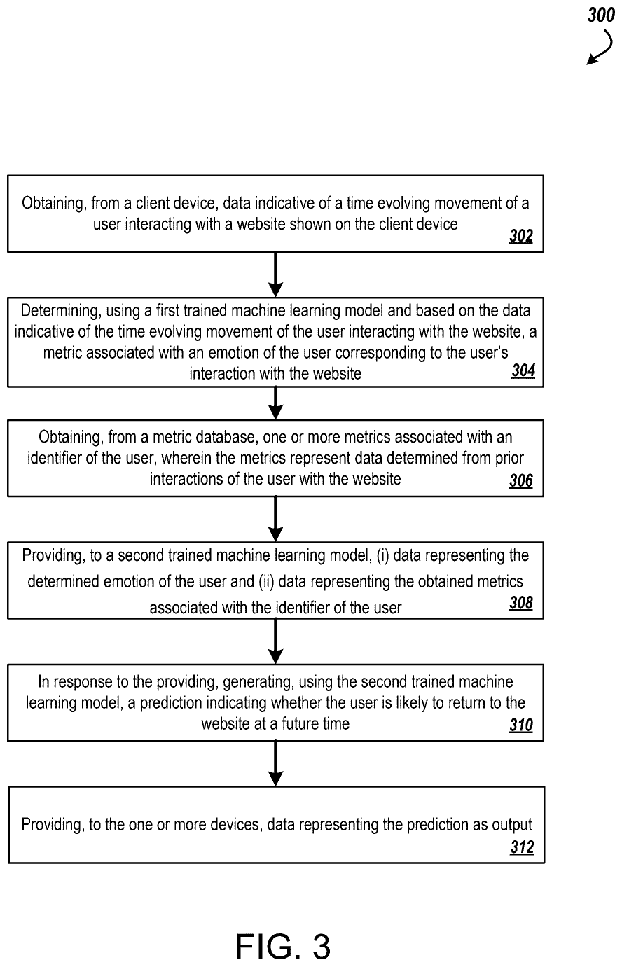

FIG. 3 is a flow diagram that illustrates an example of a process 300 for prediction a return to a website according to gesture based emotion recognition. A detection system, such as detection system 103, can perform the process 300.

During 302, the detection system obtains, from a client device, data indicative of a time evolving movement of a user interacting with a website shown on the client device. Obtaining the data includes the detection system determining normalized and calibrated values for the data indicative of the time evolving movement. The system can generate feature values that characterize the normalized values. For example, the generated feature values include at least one of speed, acceleration, contract duration, a change in contact pressure, or a finger size. Moreover, the detection system can obtain the data indicative of the time evolving movement of a portion of a body of the user with the website shown the client device, and the portion of the body includes a finger and the client device includes a touchscreen display. Here, the data indicative of the time evolving movement includes a plurality of contacts established sequentially between a finger of the user and a surface of a touchscreen display of the client device at corresponding contact times, wherein the plurality of contacts includes contact positions, contact pressures, and the contact times associated with each of the contacts.

During 304, the detection system determines, using a first trained machine learning model and based on the data indicative of the time evolving movement of the user interacting with the website, a metric associated with an emotion of the user corresponding to the user's interaction with the website. The detection system provides the data indicative of the time evolving movement of the user as input to the first machine learning model. The first machine learning model generates an output that is a metric of the user emotion. For example, the detection system obtains, from the first trained machine learning model, a vector that includes a plurality of emotions and a likelihood for each emotion of the plurality of emotions. The likelihood for each emotion represents how likely a corresponding emotion represents that data indicative of the time evolving movement of the user. The detection system can compare the likelihood for each emotion of the plurality of emotions to a threshold value. In response to comparing the likelihood for each emotion of the plurality of emotions to the threshold value, the detection system can select, as the metric associated with the emotion, the emotion of the plurality of emotions whose likelihood satisfies the threshold value, wherein the metric includes a label for the emotion and a corresponding likelihood for the emotion.

During 306, the detection system obtains, from a metric database, one or more metrics associated with an identifier of the user, wherein the metrics represent data determined from prior interactions of the user with the website. In particular, the detection system can determine the identifier of the user that performed a time evolving movement on the client device with the website. The identifier can include, for example, an identifier that does not personally reveal information about the user, and may include the visitor ID. The detection system can select, from the metrics database, the one or more metrics associated with the identifier of the user. The metrics include at least one of a session ID, a visitor ID, a visit count, a return, a session duration, a first impression, a number of emotions expressed, a duration of emotions expressed, entry and exit local times, or engagement information.

During 308, the detection system provides, to a second trained machine learning model, (i) the metric associated with the emotion of the user and (ii) data representing the obtained metrics associated with the identifier of the user. The second trained machine learning model includes a Light Gradient Boosting Machine. For example, the detection system provides, to the Light Gradient Boosting Machine, (i) the metric associated with the emotion of the user and (ii) data representing the obtained metrics associated with the identifier of the user further comprises providing, to the Light Gradient Boosting Machine, (i) the metric associated with the emotion of the user and (ii) the data representing the obtained metrics associated with the identifier of the user, wherein the Light Gradient Boosting Machine is configured to process numerical and categorical features to predict whether the user is likely to return to the website.

During 310, in response to the providing, the detection system generates, using the second trained machine learning model, a prediction indicating whether the user is likely to return to the website at a future time. Here, the detection system generates, using the second trained machine learning model, a prediction indicating the user is likely to return to the website at the future time. Alternatively, the detection system generates, using the second trained machine learning model, a prediction indicating the user is not likely to return to the website at the future time.

In some implementations, the detection system can generate a training dataset that includes instances labeled according to whether the user returned to the website. The detection system can apply an oversampling technique to the training dataset to generate additional instances of the user returning to the website. A machine learning model can be trained using the oversampled data set, the machine learning model is trained to generate the prediction indicating whether the user is likely to return to the website at a future time. In response to training the machine learning model, the detection system can set the trained machine learning model as the second trained machine learning model for deployment.

During 312, the detection system provides, to one or more devices, data representing the prediction as output. In some cases, the one or more devices can be separate devices from the client device that provided the data indicative of the time evolving movement of the user. The one or more devices can be devices associated with a developer, a third party, or another party. In some cases, the one or more devices can include the client device that provided the data indicative of the time evolving movement of the user.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification), or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining, from a client device, data indicative of a time evolving movement of a user interacting with a website shown on the client device;
determining, using a first trained machine learning model and based on the data indicative of the time evolving movement of the user interacting with the website, a metric associated with an emotion of the user corresponding to the user's interaction with the website;
obtaining, from a metric database, one or more metrics associated with an identifier of the user, wherein the metrics represent data determined from prior interactions of the user with the website;
providing, to a second trained machine learning model, (i) the metric associated with the emotion of the user and (ii) data representing the obtained metrics associated with the identifier of the user;
in response to the providing, generating, using the second trained machine learning model, a prediction indicating whether the user is likely to return to the website at a future time; and
providing, to one or more devices, data representing the prediction as output.

2. The computer-implemented method of claim 1, wherein obtaining the data indicative of the time evolving movement of the user with the website shown on the client device further comprises:
determining normalized values for the data indicative of the time evolving movement; and
generating feature values that characterize the normalized values, wherein the generated feature values comprise at least one of speed, acceleration, contact duration, a change in contact pressure, or a finger size.

3. The computer-implemented method of claim 1, wherein obtaining the data indicative of the time evolving movement of the user with the website shown on the client device further comprises:
obtaining, from the client device, the data indicative of the time evolving movement of a portion of a body of the user with the website shown on the client device,
wherein the portion of the body comprises a finger and the client device comprises a touchscreen display.

4. The computer-implemented method of claim 1, wherein determining the metric associated with an emotion of the user corresponding to the user's interaction with the website comprises:
obtaining, from the first trained machine learning model, a vector that comprises a plurality of emotions and a likelihood for each emotion of the plurality of emotions, wherein a likelihood represents how likely a corresponding emotion represents the data indicative of the time evolving movement of the user;
comparing the likelihood for each emotion of the plurality of emotions to a threshold value; and
in response to comparing the likelihood for each emotion of the plurality of emotions to the threshold value, selecting, as the metric associated with the emotion, the emotion of the plurality of emotions whose likelihood satisfies the threshold value, wherein the metric comprises a label for the emotion and a corresponding likelihood for the emotion.

5. The computer-implemented method of claim 1, wherein obtaining the one or more metrics associated with the identifier of the user further comprises:
determining the identifier of the user that performed a time evolving movement on the client device with the website; and
selecting, from the metric database, the one or more metrics associated with the identifier of the user, wherein the one or more metrics comprise at least one of a session ID, a visitor ID, a visit count, a return, a session duration, a first impression, a number of emotions expressed, a duration of emotions expressed, entry and exit local times, or engagement information.

6. The computer-implemented method of claim 1, wherein the second trained machine learning model comprises a Light Gradient Boosting Machine.

7. The computer-implemented method of claim 6, wherein providing, to a second trained machine learning model, (i) the metric associated with the emotion of the user and (ii) data representing the obtained metrics associated with the identifier of the user further comprises providing, to the Light Gradient Boosting Machine, (i) the metric associated with the emotion of the user and (ii) the data representing the obtained metrics associated with the identifier of the user, wherein the Light Gradient Boosting Machine is configured to process numerical and categorical features to predict whether the user is likely to return to the website.

8. The computer-implemented method of claim 1, wherein generating, using the second trained machine learning model, a prediction indicating whether the user is likely to return to the website at a future time further comprises at least one of:
generating, using the second trained machine learning model, a prediction indicating the user is likely to return to the website at the future time; or
generating, using the second trained machine learning model, a prediction indicating the user is not likely to return to the website at the future time.

9. The computer-implemented method of claim 1, further comprising:
generating a training dataset comprising instances labeled according to whether the user returned to the website;
applying an oversampling technique to the training dataset to generate additional instances of the user returning to the website;
training a machine learning model using the oversampled dataset, wherein the machine learning model is trained to generate the prediction indicating whether the user is likely to return to the website at a future time; and
in response to training the machine learning model, setting the trained machine learning model as the second trained machine learning model.

10. The computer-implemented method of claim 1, wherein the data indicative of the time evolving movement of the user comprises a plurality of contacts established sequentially between a finger of the user and a surface of a touchscreen display of the client device at corresponding contact times, wherein the plurality of contacts comprises contact positions, contact pressures, and the contact times associated with each of the contacts.

11. A system comprising:
one or more computers and one or more storage devices storing instructions that are operable, when executed by the one or more computers, to cause the one or more computers to perform operations comprising:
obtaining, from a client device, data indicative of a time evolving movement of a user interacting with a website shown on the client device;
determining, using a first trained machine learning model and based on the data indicative of the time evolving movement of the user interacting with the website, a metric associated with an emotion of the user corresponding to the user's interaction with the website;
obtaining, from a metric database, one or more metrics associated with an identifier of the user, wherein the metrics represent data determined from prior interactions of the user with the website;
providing, to a second trained machine learning model, (i) the metric associated with the emotion of the user and (ii) data representing the obtained metrics associated with the identifier of the user;
in response to the providing, generating, using the second trained machine learning model, a prediction indicating whether the user is likely to return to the website at a future time; and
providing, to one or more devices, data representing the prediction as output.

12. The system of claim 11, wherein obtaining the data indicative of the time evolving movement of the user with the website shown on the client device further comprises:
determining normalized values for the data indicative of the time evolving movement; and
generating feature values that characterize the normalized values, wherein the generated feature values comprise at least one of speed, acceleration, contact duration, a change in contact pressure, or a finger size.

13. The system of claim 11, wherein obtaining the data indicative of the time evolving movement of the user with the website shown on the client device further comprises:
obtaining, from the client device, the data indicative of the time evolving movement of a portion of a body of the user with the website shown on the client device,
wherein the portion of the body comprises a finger and the client device comprises a touchscreen display.

14. The system of claim 11, wherein determining the metric associated with an emotion of the user corresponding to the user's interaction with the website comprises:
obtaining, from the first trained machine learning model, a vector that comprises a plurality of emotions and a likelihood for each emotion of the plurality of emotions, wherein a likelihood represents how likely a corresponding emotion represents the data indicative of the time evolving movement of the user;
comparing the likelihood for each emotion of the plurality of emotions to a threshold value; and
in response to comparing the likelihood for each emotion of the plurality of emotions to the threshold value, selecting, as the metric associated with the emotion, the emotion of the plurality of emotions whose likelihood satisfies the threshold value, wherein the metric comprises a label for the emotion and a corresponding likelihood for the emotion.

15. The system of claim 11, wherein obtaining the one or more metrics associated with the identifier of the user further comprises:
determining the identifier of the user that performed a time evolving movement on the client device with the website; and
selecting, from the metric database, the one or more metrics associated with the identifier of the user, wherein the one or more metrics comprise at least one of a session ID, a visitor ID, a visit count, a return, a session duration, a first impression, a number of emotions expressed, a duration of emotions expressed, entry and exit local times, or engagement information.

16. The system of claim 11, wherein the second trained machine learning model comprises a Light Gradient Boosting Machine.

17. The system of claim 16, wherein providing, to a second trained machine learning model, (i) the metric associated with the emotion of the user and (ii) data representing the obtained metrics associated with the identifier of the user further comprises providing, to the Light Gradient Boosting Machine, (i) the metric associated with the emotion of the user and (ii) the data representing the obtained metrics associated with the identifier of the user, wherein the Light Gradient Boosting Machine is configured to process numerical and categorical features to predict whether the user is likely to return to the website.

18. The system of claim 11, wherein generating, using the second trained machine learning model, a prediction indicating whether the user is likely to return to the website at a future time further comprises at least one of:
generating, using the second trained machine learning model, a prediction indicating the user is likely to return to the website at the future time; or
generating, using the second trained machine learning model, a prediction indicating the user is not likely to return to the website at the future time.

19. The system of claim 11, further comprising:
generating a training dataset comprising instances labeled according to whether the user returned to the website;
applying an oversampling technique to the training dataset to generate additional instances of the user returning to the website;
training a machine learning model using the oversampled dataset, wherein the machine learning model is trained to generate the prediction indicating whether the user is likely to return to the website at a future time; and
in response to training the machine learning model, setting the trained machine learning model as the second trained machine learning model.

20. A non-transitory computer-readable medium storing software comprising instructions executable by one or more computers which, upon such execution, cause the one or more computers to perform operations comprising:
obtaining, from a client device, data indicative of a time evolving movement of a user interacting with a website shown on the client device;
determining, using a first trained machine learning model and based on the data indicative of the time evolving movement of the user interacting with the website, a metric associated with an emotion of the user corresponding to the user's interaction with the website;
obtaining, from a metric database, one or more metrics associated with an identifier of the user, wherein the metrics represent data determined from prior interactions of the user with the website;
providing, to a second trained machine learning model, (i) the metric associated with the emotion of the user and (ii) data representing the obtained metrics associated with the identifier of the user;
in response to the providing, generating, using the second trained machine learning model, a prediction indicating whether the user is likely to return to the website at a future time; and
providing, to one or more devices, data representing the prediction as output.
